(19) United States
(12) Patent Application Publication
(10) Pub. No.: US 2026/0278467 A1
(43) Pub. Date: Sep. 17, 2026

(54) SYSTEMS AND METHODS FOR CLUSTERING AND SEPARATING GRAPH NETWORKS

(71) Applicant: Kinaxis Inc., Ottawa (CA)

(72) Inventors: Sebastien Ouellet, Ottawa (CA); Ujan Sen, Ottawa (CA); Edwin Thomas, Ottawa (CA)

(73) Assignee: Kinaxis Inc., Ottawa (CA)

(21) Appl. No.: 19/562,924

(22) Filed: Mar. 11, 2026

Related U.S. Application Data
(60) Provisional application No. 63/769,968, filed on Mar. 11, 2025.

(51) Int. Cl. G06N 20/00; G06N 5/02

(52) U.S. Cl. CPC G06N 20/00; G06N 5/02

(57) ABSTRACT

Systems and methods for decomposing an optimization problem to reduce solve time. Input data associated with the optimization problem is read and the problem is represented as a graph comprising nodes and edges. A machine learning technique clusters the nodes into a plurality of clusters, and an association between constraints and edges spanning the clusters is obtained. For each constraint, a distribution of predicted load among the clusters is determined based on demand information generated by a machine learning model trained on the input data. At least one constraint is then split across the plurality of clusters in accordance with the predicted load distribution.

This application claims priority on U.S. Ser. No. 63/769,968 filed on Mar. 11, 2025, which is incorporated herein in its entirety, by reference.

### BACKGROUND

Large manufacturing problems involve material requirements planning calculations. Such problems incur long solve times to produce a solution that satisfies demands according to planning parameters such as available supplies, labor constraints, transfers, etc. The solution includes directives about what to order, move, manufacture, etc. for every day/week/month of the planning horizon. Solve times refer to the execution time to get a solution given the input data.

There is a need to reduce solve times.

### BRIEF SUMMARY

Systems and methods disclosed herein reduce solve times for the aforementioned problem, by identifying where the problem may be decomposed into sub-problems that are independent from each other.

Systems and methods disclosed herein allow for decomposing a problem that is represented as a network of components, into independent sub-networks that can be solved concurrently. Given that the solution depends on search-based methods with calculation times growing superlinearly, this decomposition allows much faster solve times. This is done through a combination of expert rules, unsupervised learning and regression tasks, producing surrogate approximations for the boundaries between sub-networks.

In one aspect, a system is provided that includes a processor; and a memory storing instructions that, when executed by the processor, cause the system to: read input data associated with an optimization problem; represent the optimization problem as a graph includes nodes and edges; apply a machine learning technique to cluster the nodes of the graph into a plurality of clusters; obtain an association between constraints and edges of the graph across the plurality of clusters; for each constraint, determine a distribution of predicted load among the plurality of clusters based on demand information generated by a machine learning model trained on the input data; and split at least one constraint across the plurality of clusters.

When splitting the constraint, the system can be further configured to: identify a cluster associated with a largest portion of the predicted load; identify one or more remaining clusters as candidate clusters for constraint partitioning; generate at least one new constraint for each of the candidate clusters, each new constraint having an assigned available rate based on the predicted load distribution; associate the new constraints with the candidate clusters; and update an available rate of the constraint associated with the identified cluster.

The system may also include where the machine learning technique includes unsupervised machine learning. The system may also include where the graph includes a network graph representing an optimization family. The system may also include where the demand information is generated by a predictive machine learning model trained on historical demand data, the predictive machine learning model including at least one of a regression model, neural network, ensemble model, or time-series forecasting model. The system may also include where the constraints include capacity, rate, or availability constraints associated with edges of the graph. The system may also include where splitting the constraint is performed iteratively or recursively until a termination condition is satisfied, the termination condition including at least one of a minimum load threshold, a minimum cluster size, or a convergence criterion. Other technical features may be readily apparent to one skilled in the art from the following figures, descriptions, and claims.

In one aspect, a non-transitory computer-readable storage medium is provided, storing instructions that, when executed that when executed by a computer, cause the computer to: read input data associated with an optimization problem; represent the optimization problem as a graph includes nodes and edges; apply a machine learning technique to cluster the nodes of the graph into a plurality of clusters; obtain an association between constraints and edges of the graph across the plurality of clusters; for each constraint, determine a distribution of predicted load among the plurality of clusters based on demand information generated by a machine learning model trained on the input data; and split at least one constraint across the plurality of clusters.

When splitting the constraint, the computer can be further configured to: identify a cluster associated with a largest portion of the predicted load; identify one or more remaining clusters as candidate clusters for constraint partitioning; generate at least one new constraint for each of the candidate clusters, each new constraint having an assigned available rate based on the predicted load distribution; associate the new constraints with the candidate clusters; and update an available rate of the constraint associated with the identified cluster.

The non-transitory computer-readable storage medium may also include where the machine learning technique includes unsupervised machine learning. The non-transitory computer-readable storage medium may also include where the graph includes a network graph representing an optimization family. The non-transitory computer-readable storage medium may also include where the demand information is generated by a predictive machine learning model trained on historical demand data, the predictive machine learning model including at least one of a regression model, neural network, ensemble model, or time-series forecasting model. The non-transitory computer-readable storage medium may also include where the constraints include capacity, rate, or availability constraints associated with edges of the graph. The non-transitory computer-readable storage medium may also include where splitting the constraint is performed iteratively or recursively until a termination condition is satisfied, the termination condition including at least one of a minimum load threshold, a minimum cluster size, or a convergence criterion. Other technical features may be readily apparent to one skilled in the art from the following figures, descriptions, and claims.

In one aspect, a computer-implemented method is provided that includes: reading, by a processor, input data associated with an optimization problem; representing, by the processor, the optimization problem as a graph includes nodes and edges; applying, by the processor, a machine learning technique to cluster the nodes of the graph into a plurality of clusters; obtaining, by the processor, an association between constraints and edges of the graph across the plurality of clusters; for each constraint, determining, by the processor, a distribution of predicted load among the plurality of clusters based on demand information generated by a machine learning model trained on the input data; and splitting, by the processor, at least one constraint across the plurality of clusters.

When splitting the constraint, the method can further include: identifying, by the processor, a cluster associated with a largest portion of the predicted load; identifying, by the processor, one or more remaining clusters as candidate clusters for constraint partitioning; generating, by the processor, at least one new constraint for each of the candidate clusters, each new constraint having an assigned available rate based on the predicted load distribution; associating, by the processor, the new constraints with the candidate clusters; and updating, by the processor, an available rate of the constraint associated with the identified cluster.

The method may also include where the machine learning technique includes unsupervised machine learning. The method may also include where the graph includes a network graph representing an optimization family. The method may also include where the demand information is generated by a predictive machine learning model trained on historical demand data, the predictive machine learning model includes at least one of a regression model, neural network, ensemble model, or time-series forecasting model. The method may also include where the constraints include capacity, rate, or availability constraints associated with edges of the graph. The method may also include where splitting the constraint is performed iteratively or recursively until a termination condition is satisfied, the termination condition includes at least one of a minimum load threshold, a minimum cluster size, or a convergence criterion. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for clustering and separating graph networks, in accordance with one embodiment.

FIG. 2 illustrates a block diagram in accordance with one embodiment.

FIG. 3 illustrates a graph representation in accordance with one embodiment.

FIG. 4 illustrates clustering of nodes in accordance with one embodiment.

FIG. 5A illustrates a clustered optimization family before a graph cut based on Constraint edges, in accordance with one embodiment.

FIG. 5B illustrates the clustered optimization family from FIG. 5A, after a graph cut based on Constraint edges, in accordance with one embodiment.

FIG. 6 illustrates a graph cut based on Transfer edges, in accordance with one embodiment.

FIG. 7 illustrates a graph cut based on BOM edges, in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

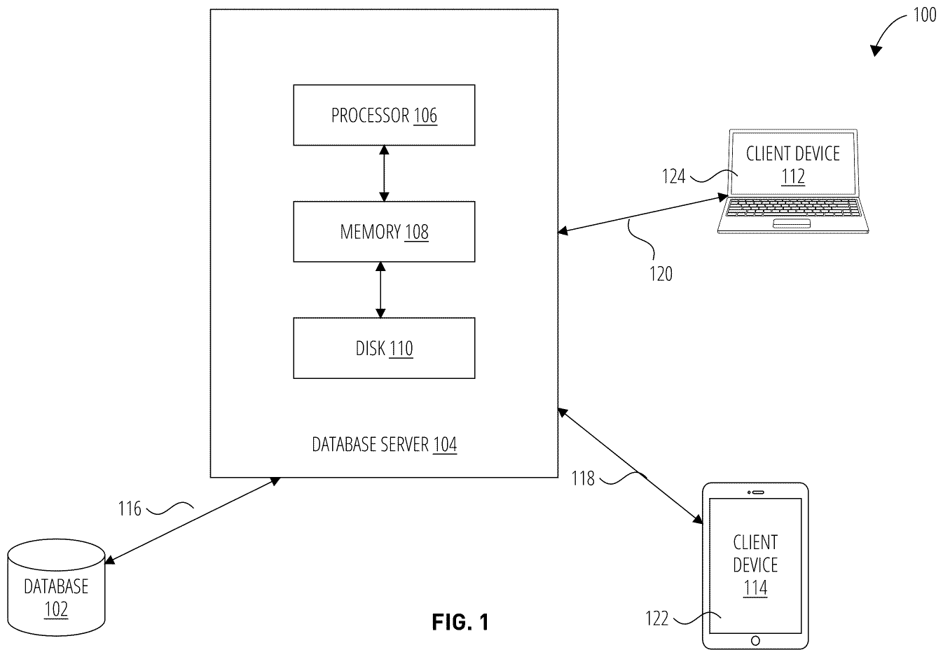

FIG. 1 illustrates an example of a system 100 for clustering and separating graph networks, in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

In the present disclosure, the terms “process” and “algorithm” are used interchangeably, and may refer to a set of steps performed in relation to an in-memory database, such as a versioned database. As referred to herein, for example, a deterministic process may be considered to be equivalent to a deterministic algorithm. A deterministic algorithm always produces the same output given a particular input. For example, an algorithm that always returns an output of Y with an input of X is deterministic. So, every time there is an input of X, it is known that the answer is Y. The result does not have to be unique, for example an input of Q can also return an output of Y, just deterministic. For a deterministic algorithm, once the input is known, the answer or output is already known, and it is not necessary to send the input to the algorithm at all.

In some implementations, a server memory may store an in-memory database as well as calculated results from processes or algorithms that are executed in relation to contents of the in-memory database. In some implementations, the calculated results may include about half of the server memory.

Reference to “in-memory” storage may refer to a server memory associated with database server 104, which may include memory 108 and/or database 102. Reference to “on-disk” storage may refer to disk 110 and/or other disks, for example disks associated with cloud storage.

In known approaches, both data (e.g. a versioned database) and calculations (e.g. calculated results) are stored in-memory. Such an approach is fast but also expensive. There is also a drawback that calculated results stored in-memory do not persist to disk when the server is restarted. The first time a calculation is performed, not only do all of the records need to be in-memory, but also the calculation structures must be built up in memory.

Embodiments of the present disclosure save memory and improve performance. Embodiments of the present disclosure avoid the time required to re-calculate the results, even the first time after server startup. Servers may have complicated invalidation rules. Even if something is stored in-memory, if the database changes, the results may be incorrect. Analytics results may also be lost from memory if the server detects that it is running out of memory. Embodiments of the present disclosure seek to solve one or more problems associated with known approaches, including wasted time and resources spent recalculating results.

A deterministic process as referred to herein may include an embedded algorithm, such as a supply chain algorithm used to analyze or calculate results based on an in-memory versioned database. An embedded algorithm may be implemented as a TypeScript algorithm. A deterministic process may include a core algorithm the results of which may not be serializable, for example if they are in-memory C++ objects that refer to other memories and other pointers.

Embodiments of the present disclosure may establish two tiers of storage, where the system may promote or demote a result. According to known approaches, some databases only exist in-memory, or only on-disk. Embodiments of the present disclosure provide a method of demoting content from in-memory to on-disk, or promoting content from on-disk to in-memory, for example in response to a server command or indication. If a result is not previously calculated, it can go from nowhere to in-memory or on-disk. In-memory is typically one tier, but on-disk can be one or more tiers. Embodiments of the present disclosure may be configured to provide an n-tier solution, for example where cloud storage provides different types of disks with different speeds of access, and the system may promote/demote to faster or slower disks in different on-disk tiers. Promoting/demoting refers to moving the results around, and is with respect to speed of access to the memory or disk(s).

A manufacturing problem can be represented as a network of interconnected components. Within this network, relationships that are suitable for separation into independent sub-networks are identified and replaced with surrogate network components. These surrogate components preserve feasibility and solution quality, ensuring that essential information—such as part substitutions and capacity constraints—is maintained during decomposition.

Examples of surrogate elements can include: surrogate demand nodes that represent a dependent demand flowing from one sub-network into another; surrogate capacity or constraint nodes that capture capacity limits originally enforced by a shared constraint across multiple clusters; surrogate supply nodes representing predicted supply transferred across a severed transfer edge; surrogate BOM component nodes representing the quantity of components needed after a bill-of-materials relationship is cut; and Surrogate parameter values, such as adjusted constraint-available rates, substitute-part availability, or predicted allocation quantities.

The disclosed systems and methods may include data-collection processes, a regression-based machine learning model, an unsupervised clustering task, one or more network-representation transformations, and rules for generating surrogate components.

In operation, relevant manufacturing data is first identified and used to construct a comprehensive network of components and relationships, which may contain more than 100,000 elements. A clustering algorithm can be applied to determine which relationships can be severed to create independent sub-networks. Domain-specific rules may then be used to introduce surrogate components wherever needed to maintain feasibility and quality. Parameters for these surrogate components can be predicted using a regression-based machine learning model.

The machine learning model may be trained prior to deployment by:
1. Collecting output data from fully solved manufacturing problems;
2. Constructing network representations for those problems; and
3. Learning patterns between input data, network structures, and corresponding outputs.

The resulting model generalizes to previously unseen problems and may also be further tuned for a specific set of current problems to improve surrogate-component accuracy.

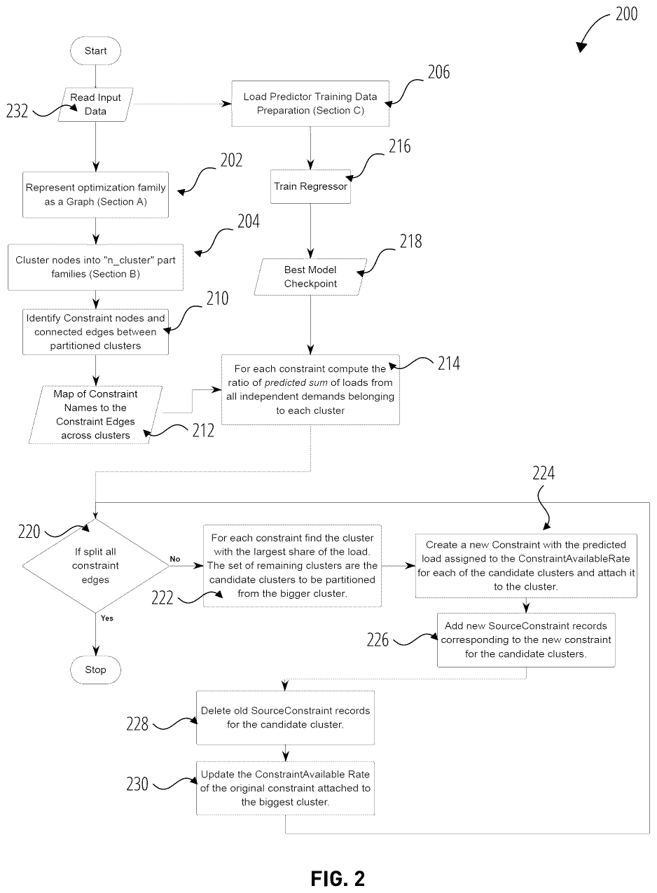

FIG. 2 illustrates a Block diagram 200 in accordance with one embodiment.

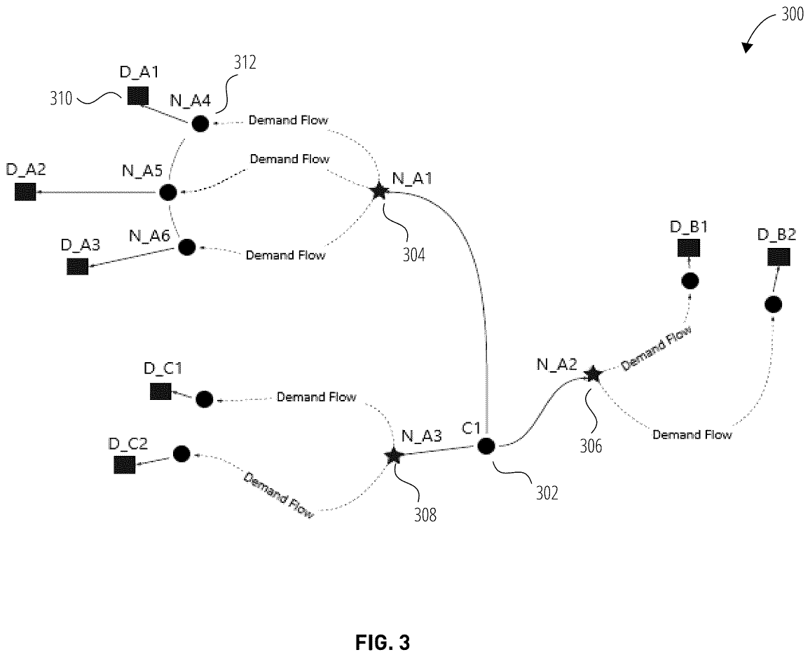

At block 232, the system reads the input data. At block 202, the system represents the optimization family as a network graph. The graph representation is described in further detail with respect to FIG. 3. At block 204, the nodes of the graph are clustered into multiple clusters. At block 210, the system identifies constraint nodes and the edges connecting those nodes across the clusters, thereby generating a mapping of constraint names to associated constraint edges, as shown in output 212. Using this mapping, block 214 computes, for each constraint, a ratio of a predicted load contributed by the independent demands associated with each cluster.

The predicted loads are generated by a machine-learning process involving blocks 206 and 216 and output 218. At block 206, the system prepares training data for a load predictor using the input data. At block 216, the system trains one or more machine-learning models on the prepared data, and output 218 selects the model providing the highest predictive accuracy. The selected model supplies the predicted load values used in block 214.

Following execution of block 214, decision block 220 determines whether all constraint edges identified at block 210 have been split. If any constraint edge remains unsplit, the system recursively processes the clusters until all such edges have been split.

The recursive procedure is carried out through blocks 222, 224, 226, 228, and 230. At block 222, for each constraint, the system identifies the cluster having the greatest share of the predicted load. The remaining clusters are designated as candidate clusters for separation. At block 224, the system creates, for each candidate cluster, a new constraint having a ConstraintAvailableRate equal to the predicted load for that cluster, and attaches the new constraint to the cluster. At block 226, the system generates new SourceConstraint records for each new constraint, and at block 228, removes the prior SourceConstraint records for the corresponding clusters. At block 230, the system updates the ConstraintAvailableRate of the original constraint associated with the cluster having the largest load share. This recursive splitting continues until decision block 220 indicates that no further splitting is required.

FIG. 3 illustrates a graph representation 300 of an optimization family in accordance with one embodiment.

Each optimization family may be represented as a graph that includes multiple nodes. In some embodiments, each node is defined as a tuple containing two features—for example, “PartId” and “SiteId.” In addition to part nodes, the graph may include sentinel nodes representing a constraint (e.g., C1) and an independent demand (e.g., D_A1). These sentinel nodes are connected respectively to constraint-sink nodes (e.g., N_A1) and demand-consumption nodes (e.g., N_A4). That is, a sentinel node that represents a constraint is connected to one or more constraint-sink nodes, while a sentinel node that represents an independent demand is connected to one or more demand-consumption nodes. In FIG. 3, sentinel node representing constraint C1 (302) is connected to constraint sink nodes N_A1 (304), N_A2 (306) and N_A3 (308). Furthermore, sentinel node representing independent demand D_A1 (310) is connected to demand-consumption node N_A4 (312).

A “Demand Flow” is a graph path extending from a demand node to a part-source node that satisfies the demand. A “Constraint Sink Node” is a node added to the graph to represent a constraint and is attached to all nodes subject to that constraint. A “Constrained Node” is any node connected to a constraint sink node by a constraint edge.

The graph includes directed edges representing relationships among nodes. These edges may include: a BOM edge, which is a directed edge from a part to its assembly node; a transfer edge, which is a directed edge from a node corresponding to a PartSource to a node corresponding to a transferred part; and a constraint edge, which is a directed edge from a constraint node to the corresponding constraint-sink node. the “constraint sink” node.

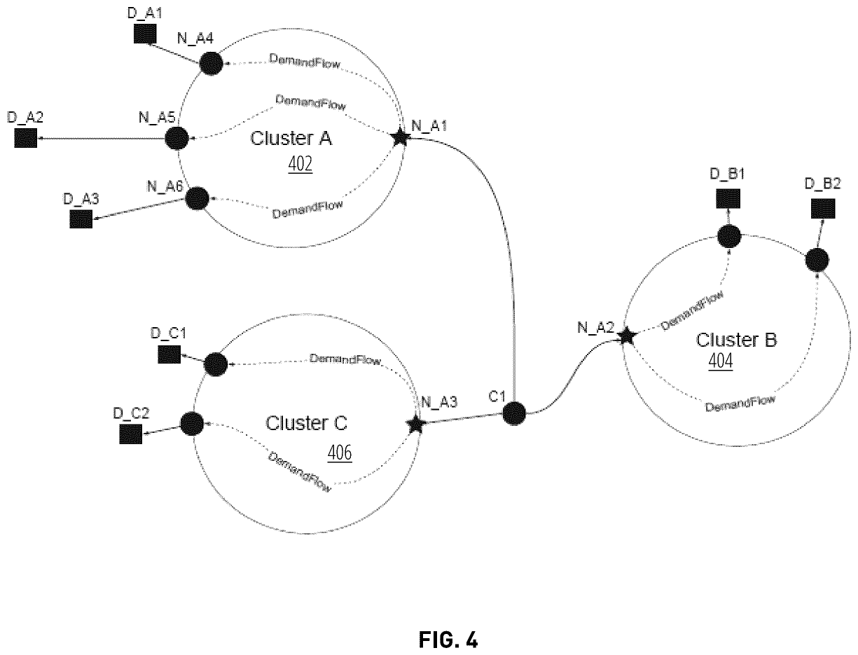

FIG. 4 illustrates clustering of nodes in accordance with one embodiment. The optimization family shown in FIG. 4 are identical to that shown in FIG. 3, except now the nodes are clustered into 3 clusters: Cluster A 402, Cluster B 404 and Cluster C 406.

In FIG. 4, nodes can be partitioned and labels may be assigned, An optimization family can be partitioned by using a suitable clustering algorithm (for example, Agglomerative Clustering) or other community detection algorithms. The graph can be represented in the form of an adjacency matrix whose weights correspond to the distances between a given pair of nodes in the graph. To incentivize splitting the graph on constraint nodes, a higher weight can be assigned for edges that connect “constraint nodes” to “constraint sink nodes”. Furthermore, a total number of clusters (“n_clusters”) can be upper bounded by the total constraints in the part optimization family to avoid erroneous splits on non-constraint edges. The clustering algorithm can assign cluster ids to every node in the graph, which is used for splitting the part family.

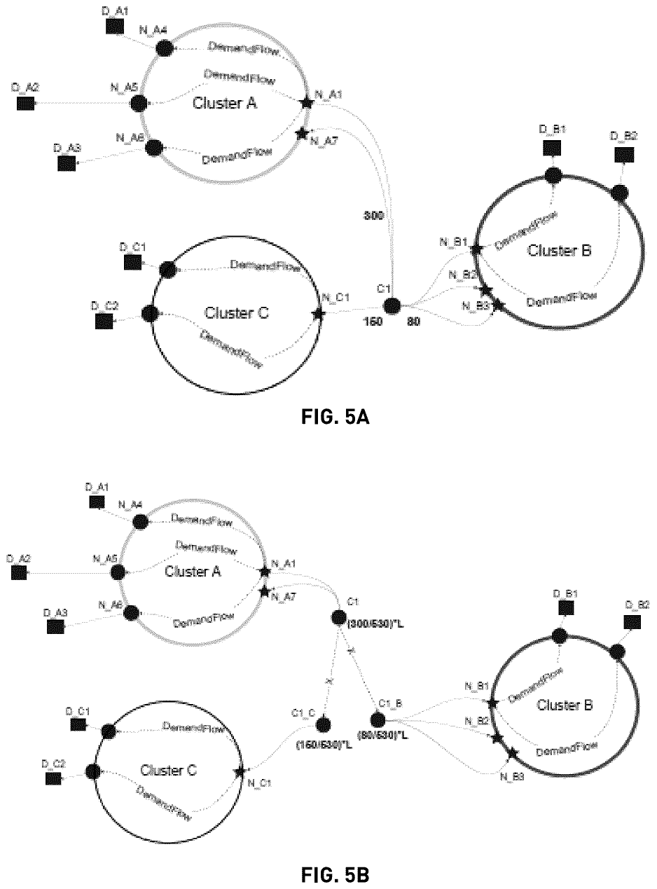

FIG. 5A illustrates a clustered optimization family before a graph cut based on Constraint edges, in accordance with one embodiment.

In FIG. 5A, there are three clusters that are connected by a common constraint (C1): Cluster A, Cluster B and Cluster C. The constraint sinks of Cluster A are N_A1, N_A7. Cluster B has 3 constraint sinks, namely N_B1, N_B2 and N_B3, and Cluster C has constraint sinks D_C1 and D_C2.

The predicted load on C1 due to independent demands of Cluster A (D_A1, D_D2 and D_A3) sums up to 300. Similarly the predicted load on C1 due to Cluster B is 80, while the predicted load on C1 due to C is 150.

Based on these absolute predictions, the total predicted load on C1 is (80+150+300=530) Therefore the predicted load ratio for each cluster is ~0.56*L for Cluster A, ~0.28*L for Cluster B and ~0.15*L for Cluster C, where L corresponds to the original constraint available rate for constraint C1.

FIG. 5B illustrates the clustered optimization family from FIG. 5A, after a graph cut based on Constraint edges, in accordance with one embodiment.

Following from FIG. 5A, since Cluster A has the largest load ratio, the constraint (C1) is retained for cluster A, by reducing the load ratio by the contribution from the remaining clusters. Two new constraints are created each for Cluster B and Cluster C with their respective predicted load ratios, as shown in FIG. 5B. Cluster B has a constraint C1_B, with a load ratio of [50/530]*L. Cluster C has a constraint C1_C, with a load ratio of [150/530]*L.

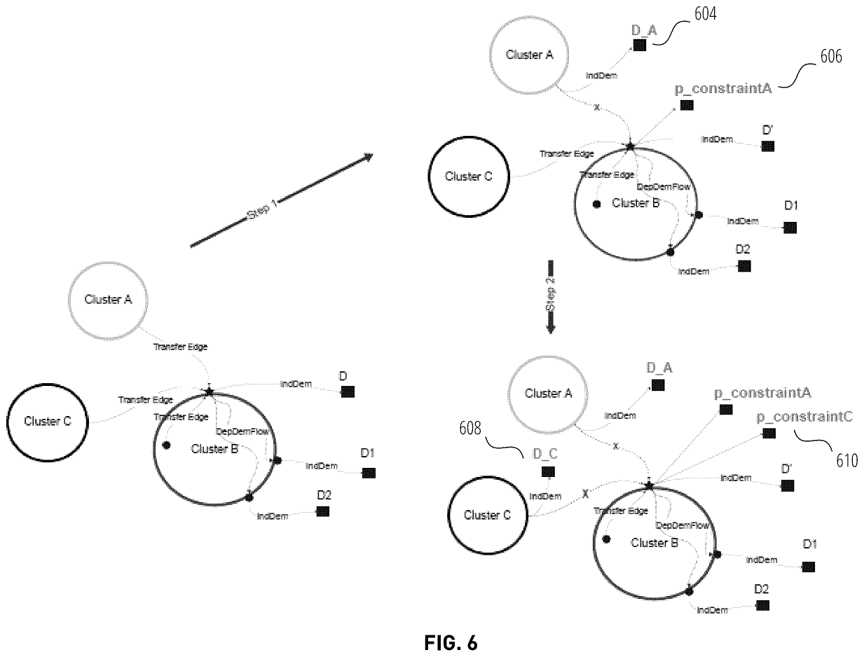

FIG. 6 illustrates a graph cut based on Transfer edges, in accordance with one embodiment. In FIG. 6, an example of splitting a Transfer Edge between Cluster A and Cluster B is shown in two steps.

In step 1:
1) Find the sum of predicted supply allocated quantity from independent demands that pass through a transfer edge from cluster A to cluster B.
2) Create a new surrogate independent demand 604 on transfer node source in cluster A that mimics the dependent demand from cluster A to cluster B.
3) Add a constraint 606 on transfer node sink in cluster B where the constraint available rate or capacity is equal to the predicted supply from the transfer edge.

In step 2, repeat steps (1)-(3) above, between cluster B and cluster C. That is:
1) Find the sum of predicted supply allocated quantity from independent demands that pass through a transfer edge from cluster C to cluster B.
2) Create a new surrogate independent demand 608 on transfer node source in cluster C that mimics the dependent demand from cluster C to cluster B.
3) Add a constraint 610 on transfer node sink in cluster B where the constraint available rate or capacity is equal to the predicted supply from the transfer edge.

Finally, iteratively split all interconnecting transfer edges until clusters are disjointed, or there are no possible transfer edge cuts in the graph. Demands on a node can either be dependent or independent.

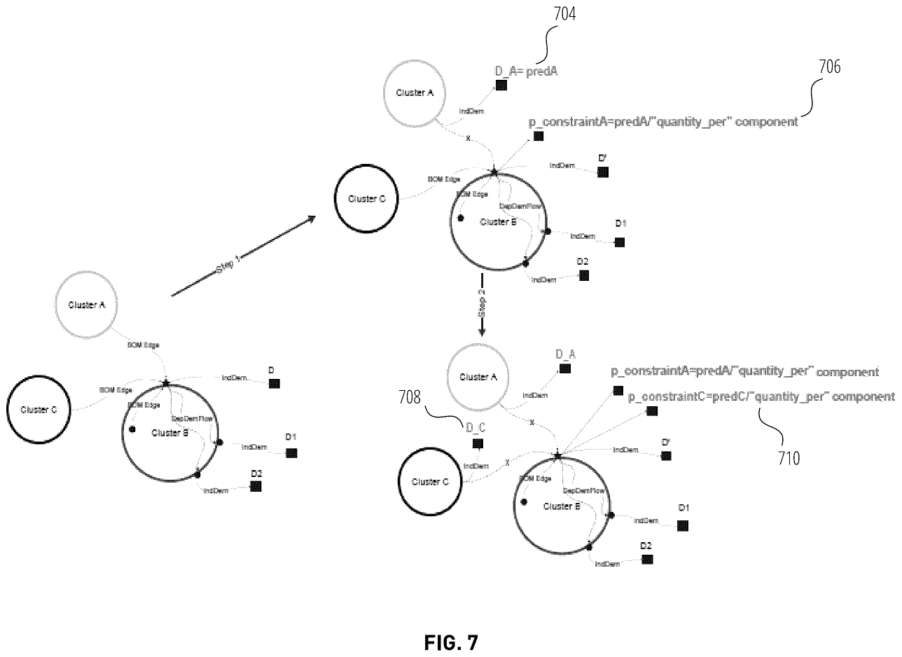

FIG. 7 illustrates a graph cut based on BOM edges, in accordance with one embodiment. In FIG. 7, an example of splitting a BOM Edge between cluster A and cluster B is shown in two steps.

In step 1:
1) Find the sum of predicted supply allocated quantity from independent demands that pass through BOM edge from cluster A to cluster B.
2) Create a new surrogate independent demand 704 on BOM component in cluster A that mimics the dependent demand from cluster A to cluster B.
3) Add a constraint 706 on the assembly node in cluster B where the constraint available rate or capacity is equal to the predicted supply from the BOM edge divided by the “quantity_per” field or the number of source components required to “make” the assembly part in cluster B.

In step 2, repeat steps (1)-(3) above, between cluster B and cluster C. That is:
1) Find the sum of predicted supply allocated quantity from independent demands that pass through BOM edge from cluster A to cluster B.
2) Create a new surrogate independent demand 708 on BOM component in cluster C that mimics the dependent demand from cluster C to cluster B.
3) Add a constraint 710 on the assembly node in cluster B where the constraint available rate or capacity is equal to the predicted supply from the BOM edge divided by the “quantity_per” field or the number of source components required to “make” the assembly part in cluster B.

Finally, iteratively split all interconnecting BOM edges until clusters are disjointed, or there are no possible BOM edge cuts in the graph. Demands on a node can either be dependent or independent.

### Block 206 in FIG. 2

### Load Predictor: Training Data Preparation Algorithm

1) For each cluster, find all the independent demand nodes and their associated demand flow. This can be done by recursively traversing data tables.
2) Filter the demand nodes to include only nodes that have a demand flow ending at a “constraint sink” node. This is done since only constraint nodes will be split.
3) Find all the dates in which the constraints of the current optimization family have been used. This can be done from data tables.
4) Compute all dates that lie within a fixed horizon range of the constraint dates used in step 3.
5) For each of the independent demand nodes (from Step 2), find the independent demand quantities that are placed with a due date that lie within the dates computed in Step 4. These can be the independent demands for which features can be prepared for training the load predictor. (For independent demands placed with the same due date and for the same node, the quantities are summed up and independent demand rows combined).
6) Compute both “Local” and “Global” graph features for each of the independent demand nodes, which can be used as training features for the load predictor.
7) The target variable is the load that is placed on a given constraint, through the constrained node as a result of the demand flow path for a given date. The target variable can be acquired by leveraging the data accessed in step 3, for the consumed constraint capacity and date of consumption, and a separate data table to acquire the part source information for mapping the consumption to a specific demand flow.
8) A suitable regression model can then be trained using training features (from Step 6) and target variable (Step 7).

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software

products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and a memory storing instructions that, when executed by the processor, cause the system to:
read input data associated with an optimization problem;
represent the optimization problem as a graph comprising nodes and edges;
apply a machine learning technique to cluster the nodes of the graph into a plurality of clusters;
obtain an association between constraints and edges of the graph across the plurality of clusters;
for each constraint, determine a distribution of predicted load among the plurality of clusters based on demand information generated by a machine learning model trained on the input data; and
split at least one constraint across the plurality of clusters.

2. The system of claim 1, wherein when splitting the constraint, the system is further configured to:
identify a cluster associated with a largest portion of the predicted load;
identify one or more remaining clusters as candidate clusters for constraint partitioning;
generate at least one new constraint for each of the candidate clusters, each new constraint having an assigned available rate based on the predicted load distribution;
associate the new constraints with the candidate clusters; and
update an available rate of the constraint associated with the identified cluster.

3. The system of claim 1, wherein the machine learning technique comprises unsupervised machine learning.

4. The system of claim 1, wherein the graph comprises a network graph representing an optimization family.

5. The system of claim 1, wherein the demand information is generated by a predictive machine learning model trained on historical demand data, the predictive machine learning model comprising at least one of a regression model, neural network, ensemble model, or time-series forecasting model.

6. The system of claim 1, wherein the constraints comprise capacity, rate, or availability constraints associated with edges of the graph.

7. The system of claim 1, wherein splitting the constraint is performed iteratively or recursively until a termination condition is satisfied, the termination condition comprising at least one of a minimum load threshold, a minimum cluster size, or a convergence criterion.

8. A non-transitory computer-readable storage medium storing instructions that, when executed that when executed by a computer, cause the computer to:
read input data associated with an optimization problem;
represent the optimization problem as a graph comprising nodes and edges;
apply a machine learning technique to cluster the nodes of the graph into a plurality of clusters;
obtain an association between constraints and edges of the graph across the plurality of clusters;
for each constraint, determine a distribution of predicted load among the plurality of clusters based on demand information generated by a machine learning model trained on the input data; and
split at least one constraint across the plurality of clusters.

9. The non-transitory computer-readable storage medium of claim 8, wherein when splitting the constraint, the computer is further configured to:
identify a cluster associated with a largest portion of the predicted load;
identify one or more remaining clusters as candidate clusters for constraint partitioning;
generate at least one new constraint for each of the candidate clusters, each new constraint having an assigned available rate based on the predicted load distribution;
associate the new constraints with the candidate clusters; and
update an available rate of the constraint associated with the identified cluster.

10. The non-transitory computer-readable storage medium of claim 8, wherein the machine learning technique comprises unsupervised machine learning.

11. The non-transitory computer-readable storage medium of claim 8, wherein the graph comprises a network graph representing an optimization family.

12. The non-transitory computer-readable storage medium of claim 8, wherein the demand information is generated by a predictive machine learning model trained on historical demand data, the predictive machine learning model comprising at least one of a regression model, neural network, ensemble model, or time-series forecasting model.

13. The non-transitory computer-readable storage medium of claim 8, wherein the constraints comprise capacity, rate, or availability constraints associated with edges of the graph.

14. The non-transitory computer-readable storage medium of claim 8, wherein splitting the constraint is performed iteratively or recursively until a termination condition is satisfied, the termination condition comprising at least one of a minimum load threshold, a minimum cluster size, or a convergence criterion.

15. A computer-implemented method comprising:
reading, by a processor, input data associated with an optimization problem;
representing, by the processor, the optimization problem as a graph comprising nodes and edges;
applying, by the processor, a machine learning technique to cluster the nodes of the graph into a plurality of clusters;
obtaining, by the processor, an association between constraints and edges of the graph across the plurality of clusters;
for each constraint, determining, by the processor, a distribution of predicted load among the plurality of clusters based on demand information generated by a machine learning model trained on the input data; and
splitting, by the processor, at least one constraint across the plurality of clusters.

16. The method of claim 15, wherein when splitting the constraint, the method further comprises:
identifying, by the processor, a cluster associated with a largest portion of the predicted load;
identifying, by the processor, one or more remaining clusters as candidate clusters for constraint partitioning;
generating, by the processor, at least one new constraint for each of the candidate clusters, each new constraint having an assigned available rate based on the predicted load distribution;
associating, by the processor, the new constraints with the candidate clusters; and
updating, by the processor, an available rate of the constraint associated with the identified cluster.

17. The method of claim 15, wherein the machine learning technique comprises unsupervised machine learning.

18. The method of claim 15, wherein the graph comprises a network graph representing an optimization family.

19. The method of claim 15, wherein the demand information is generated by a predictive machine learning model trained on historical demand data, the predictive machine learning model comprising at least one of a regression model, neural network, ensemble model, or time-series forecasting model.

20. The method of claim 15, wherein the constraints comprise capacity, rate, or availability constraints associated with edges of the graph.

21. The method of claim 15, wherein splitting the constraint is performed iteratively or recursively until a termination condition is satisfied, the termination condition comprising at least one of a minimum load threshold, a minimum cluster size, or a convergence criterion.
